(19) United States
(12) Patent Application Publication
(10) Pub. No.: US 2002/0042879 A1
(43) Pub. Date: Apr. 11, 2002

(54) Electronic signature system

(76) Inventors: Terry A. Gould, Fort Washington, MD (US); Joseph J. Robinson JR., Fort Washington, MD (US)

Correspondence Address: Mitchell B. Wasson, Esq., HOFFMAN, WASSON & GITLER, PC, Suite 522, 2361 Jefferson Davis Highway, Arlington, VA, 22202, US

(21) Appl. No.: 09/971,032

(22) Filed: Oct. 5, 2001

Related U.S. Application Data
(60) Provisional application No. 60/238,430, filed on Oct. 10, 2000.

(51) Int. Cl. H04L 9/00

(52) U.S. Cl. 713/176

(57) ABSTRACT

A method of producing an electronic signature and a system for verifying that signature by a licensed vendor. Personal information is received by an individual wishing to utilize this system. This personal information would be used to produce an electronic signature, including an authentication number. The electronic signature, as well as the means for producing the authentication number, can be created through the use of a electronic signature card. This card can be inserted into a reader and the licensed vendor can compare the generated authentication number with an authentication number associated with the individual. Once the electronic signature is verified, a particular commercial transaction can be completed. Additionally, the present invention can be used to ensure the integrity of the document after the electronic signature has been attached thereto. This invention prevents identity theft, as well as minimizing the risk of unauthorized use of the signature card to sign a document in another person's name.

The present application claims the benefit of provisional patent application Ser. No. 60/238,430, filed on Oct. 10, 2000.

### BACKGROUND OF THE INVENTION

1. Field of the Invention

The present invention is directed to a system for generating and verifying an electronic signature affixed to an electronically generated document, as well as a system for ensuring that the document has not been altered subsequent to the electronic signature being affixed thereto. This system would be used to prevent identity theft. Additionally, the present invention minimizes the risk of unauthorized use of the signature card to sign a document in another person's name.

2. Description of the Prior Art

Writing is a system of human communication by means of visual symbols or signs. The most primitive stages of writing or marking objects, date almost to the time of the earliest human beings. However, the first fully developed system of writing appeared only approximately 5,500 years ago. While these first forms of writing were established to communicate with different people at a greater distance than was possible with simply oral communications, writing was also used to record different events for posterity. As society became more commercialized, writing was also used as a means of documenting one individual's obligation to another individual, such as a contract. One method of verifying that the individuals in a contract were who they said they were, was the practice of signing the contract with the individual's name. Furthermore, to insure that the individual was who they purported to be, notary publics were created to aid in the verifying process. Another manner of verifying that a document was “trustworthy”, was the use of seals which are unique to a particular person, official, as well as a commercial enterprise.

More recently, with the advent of credit cards, a credit card slip would be generated with the purchase of various goods or services. This credit card slip was signed by the individual in possession of the credit card, thereby obligating that individual to pay for those goods or services. At the time that the individual's signature was affixed to the credit card slip, the merchant or his representative, would verify that the proper individual was signing the card by checking identification information of that individual, such as by utilizing a driver's license.

Even more recently, the use of the Internet has enabled individuals to purchase goods or services over the Internet. During this process, the user would be prompted by the merchant's web page to input the individual's credit card number, as well as other information to finalize the purchase of the goods or services. As can be appreciated, it is difficult to verify that the individual who enters the credit card information into the computer is in actuality, the owner of that credit card.

The issue of verification of an individual's signature has become even more important with the signing, on Jun. 30, 2000, by then President Clinton, of the Electronic Signatures and Global and National Commerce Act, thereby allowing electronic signatures (e-signatures) to be as legally binding as hand-written signatures for e-commerce transactions. This law went into effect on Oct. 1, 2000.

At the present time, many companies conducting business on the Internet already use digital signatures, mostly in the form of user codes and passwords. These items are assigned on an individual basis, not to be shared by multiple persons. The user codes identify an individual using a particular system and the password verifies that the individual using the user code is actually the individual to whom the code was assigned. Technology advances in the Internet and broadband communications makes it possible to be in instant communication with authentication and verification sources. This advancement makes fraud and deception harder to achieve. Some of these advances have been described in various U.S. patents, such as U.S. Pat. Nos. 5,757,917, issued to Rose et al; 5,826,245, issued to Sandberg-Diment; 5,754,656 and 5,995,626, issued to Nishioka et al; and 4,995,081, issued to Leighton et al.

The patent to Rose et al describes a computerized payment system for purchasing goods and services over the Internet. The system contemplates both the buyer and seller being issued respective card numbers 102 and 202. The system would then check these card numbers to determine whether the buyer and seller truly represent themselves. Once the identities have been verified, a transaction will be culminated. As illustrated in FIG. 1, a payment system 10 is described including an above-the-line system 40 and a below-the-line system 42, separated by a firewall 44. The firewall permits limited communication between the above-the-line system 40 and the below-the-line system 42, but prevents unauthorized access to the below-the-line system 42 through the above-the-line system 40. The firewall 44 provides security for the information contained in the below-the-line system 42 and prevents hackers on the Internet from entering the below-the-line system 42 via the above-the-line system 40 in an effort to discover information about an individual which the hacker would then use to impersonate the individual buyer.

The patent to Sandberg-Diment describes a system for the verification of information provided with respect to a transaction between an initiating party and a verification seeking party. The verification information is confirmed by a third party over the Internet. Based upon confidential information in the possession of the initiating party, first and second tokens are generated which would be sent electronically from the initiating party to both the verification seeking party, as well as the verifying party.

The patents to Nishioka et al relate to an electronic shopping system including a method of authenticating a document. As illustrated in FIGS. 18-20, a digital signature verification unit 304, 405 would be utilized employing a public key associated with a user's site apparatus, thereby authenticating a written order P generated by the user.

The patent to Leighton et al describes a method and system for personal identification using proofs of legitimacy to generate and verify a personal identification card. A password and digital signature are encoded and stored on a magnetic strip or other memory device of the card.

The patent to Bisbee et al details a system for authenticating an electronic document with a digital signature of a Transfer Agent, appending a certificate to the electronic document by the Transfer Agent and then validating the digital signature and certificate of the Transfer Agent. However, no mention is made of ensuring that the electronic document has not been altered subsequent to the affixation of the digital signature.

While the general idea of providing a means for authenticating an electronic signature utilizing a user card and a password is described in the Leighton et al patent, this reference, as well as the other cited references, recite complicated systems in which a website is utilized by both the user, as well as a verification seeking party, to authenticate the identification of an individual utilizing an electronic signature. Therefore, a simplified system and method must be developed in which both a user, as well as a vendor, would supply information to a central database which in turn, would generate an electronic signature for that user for the purpose of authenticating a document.

### SUMMARY OF THE INVENTION

The deficiencies of the prior art are addressed by the present invention for verifying that a particular document sent from a first party to a second party over the Internet, was in fact, sent by that first party. The present invention utilizes a central website employing a single large database or a plurality of databases. A business or governmental user would gain access to the material in the databases by registering with the website. Each individual user would obtain an electronic signature card provided with information thereon, as well as a personal identification number (PIN). The combination of the electronic signature card and the personal identification number, would be utilized to insure that the document is indeed, sent by the first party. The electronic signature card would have magnetic information encoded thereon, which would be entered into the system by a standard reader device which, in combination with the personal identification number, would verify the individual's signature. The electronic signature card is placed into the reader associated with a computer at the commencement of the transaction. The card would remain in the reader until the transaction is completed. This procedure is an additive security measure to ensure the user's presonal information is not compromised. Alternatively, the information contained on the magnetic card would be entered directly into a computer by a keyboard, along with the personal identification number. In this alternative, the electronic signature card would not be supplied to the user.

The electronic signatures generated by the present invention can be affixed to all e-commerce documents. Its unique identifier and non-repeating authentication number, eliminates the risk of unauthorized use of the signature, should someone intercept the code. Each authentication number is a multi-digit code generated by an algorithm for a one-time use. Only an electronic signature server containing information relating to the individual seeking authentication and the individual's electronic signature card, can generate the authentication number to complete the e-commerce transaction. The authentication number is dynamic and is virtually impossible for anyone to reproduce. Additionally, both the server and card programs, are designed to be tamper resistant.

Along with the PIN, the electronic smart card could also include various biometric information relating to the individual signing the electronic document. A special reader can be included for reading particular biometric information directly from the individual. A program provided in the smart card would compare the information contained in smart card, such as PIN with the PIN directly entered by the user. If a match occurs, the information will be sent to a data base and the electronic signature would be created and affixed to the electronic document. The special reader would be used as an input device to enter the individual biometric information to be compared with the biometric information stored on the smart card. This could be used in addition to the PIN or instead of the PIN to provide the basis of a match.

The use of the present invention would eliminate other means of identifying the individual, such as the individual's social security number, as well as driver's license identification material. A person can accidentally disclose his or her social security number and when coupled with other information, would allow someone to assume your identity for fraudulent purposes. Once an individual is registered with the system of the present invention and receives his electronic signature card, his personal data would not be used again. It is also noted that all personal information is encrypted before transmission so that accidental interception will not compromise the system. A public/private key infrastructure (PKI) would be employed. This system, which would insure that a nefarious party would not take the persona of an innocent first party, would also allow licensed vendors to independently verify the signature on a document before that document is accepted as valid. This system would therefore make it very easy to prevent the “identity theft” of a particular individual, as well as minimizing the risk of the unauthorized use of the signature card to sign a document in another person's name.

The burgeoning use of e-commerce documents, forms and contracts, would eliminate the need for these paper documents, thereby saving the government and businesses time and money, which would result in lessening of expenses for generating these documents, as well as for filing these documents in a time-consuming manner.

### BRIEF DESCRIPTION OF THE DRAWINGS

The foregoing aspects, and many of the intended advantages of the present invention, will be come more readily appreciated and better understood with references to the following detailed description, when taken in conjunction with the accompanying drawings, wherein:

FIG. 1 is a block diagram illustrating the method of registering an electronic signature;

FIG. 2 is a block diagram showing typical registration data;

FIG. 3 is a diagram showing a typical electronic signature card;

FIG. 4 is a diagram showing a typical electronic signature;

FIG. 5 is a flow diagram showing the manner in which an authentication number is generated; and

FIG. 6 is a flow diagram showing the manner in which an electronic signature is verified.

### DETAILED DESCRIPTION OF THE PRESENT INVENTION

The electronic signature system of the present invention is used to obtain an electronic signature for a particular individual by a registration process. Once the individual is registered, and one or more vendors or merchants are also registered, the present invention can be used by both the individual and the vendor or merchant, to allow the individual to affix an electronic signature to sign a particular document. Once this document is signed, the system of the present invention would be used to verify the identity of the individual signing the document.

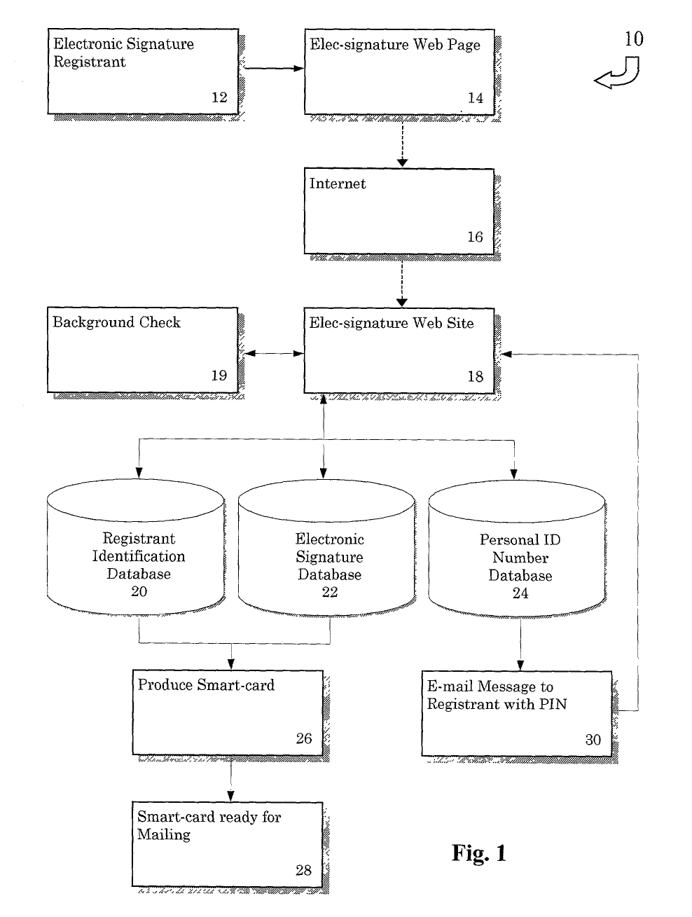

FIG. 1 illustrates the process and system for registering an individual to obtain an electronic signature. The process and system 10 begins with an individual seeking the electronic signature 12 being presented with an electronic signature page 14 generated by a website 18. The registrant would utilize a computer connected to the website 18 via the Internet 16. This connection can be established by a wired or wireless system.

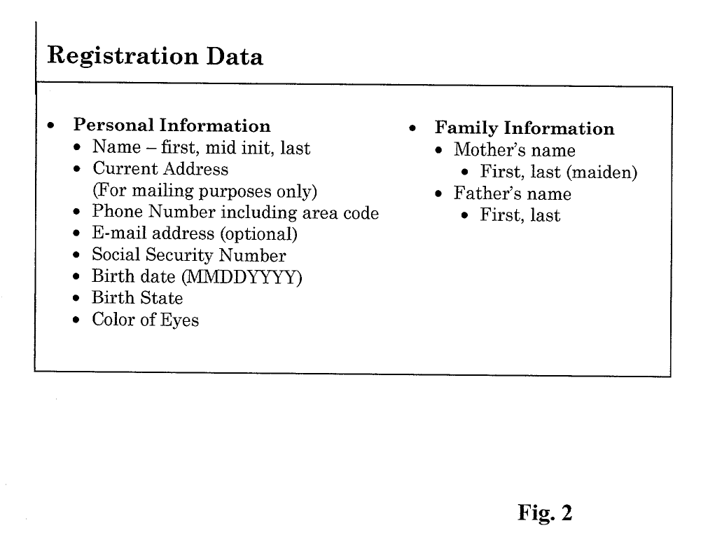

The registrant would be presented with a screen for the purpose of entering personal information as shown, for example, in FIG. 2. This personal data for registration purposes, would include such items as the registrant's first and last name, as well as their middle initial or full middle name, the registrant's current address, the registrant's phone number, including area code, as well as the registrant's social security number, birth date, birth state and color of eyes. Additionally, further information, such as the registrant's mother's name, as well as the registrant's father's name, could also be included along with any other type of personal information which would be utilized to identify the registrant. The type of information listed in FIG. 2 merely shows examples of the type of information requested. It will be appreciated that other types of information could also be requested. Although it is envisioned that the registration process would be completely conducted over the Internet, this need not be the case, and the registrant could register in person at a central location, register utilizing the telephone or through the mail. Since it is not necessary to completely register over the Internet, the registrant's e-mail address could be used as optional information. The use of the registrant's e-mail would also enable the central database to transmit information to the registrant, such as the registrant's personal identification number (PIN). All the information requested by the central website could be presented to the registrant for registration purposes utilizing one or more screens. For example, the first screen presented to the registrant might include only the personal information listed in the left column of the FIG. 2, and a second screen would include the family information listed in the right column of FIG. 2.

When the data is received at the electronic signature website, both the personal and family information will be independently verified before issuing the electronic signature and the PIN. Police and FBI databases will be checked to identify past criminal activity, as well as other relevant databases, as shown by background check 19. Once the electronic signature website is satisfied of the veracity of the information provided by the registrant, this information would be stored in the registrant identification database 20 provided at a central location. The electronic signature of the registrant would be created and stored in database 22 and the PIN of the registrant would be generated and stored in database 24. Although FIG. 1 illustrates the utilization of three databases 20, 22 and 24, it can be appreciated that more or less databases could be employed.

The present invention will issue a risk rating to licensed vendors about the individual signing the document that will indicate the presence of adverse information resulting from the background check. The risk rating is established based on a vendor's business requirements. This information may not affect the credit worthiness of the individual, but will advise the vendor of a potential risk. This risk information will be updated on a periodic basis.

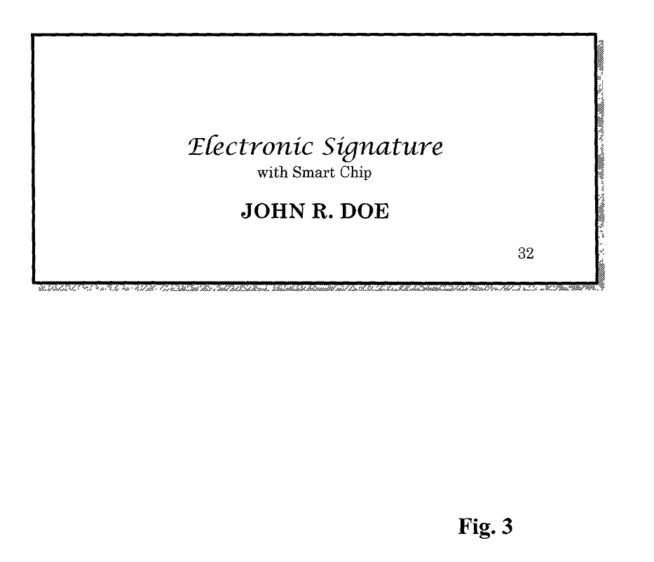

Once all the information is verified and is transmitted to the appropriate databases, an electronic signature card, as shown in FIG. 3, will be produced and mailed to the registrant, as shown by reference numerals 26 and 28. The electronic signature card will be mailed to the registrant using surface mail while observing security standards of not identifying what is contained in the envelope, nor other identifying markings. A follow-up letter would be sent to the registrant to insure that the electronic signature card has been received by the registrant.

If the registration provided an e-mail address with his registration data, an e-mail will be sent to the registrant instructing him how to retrieve his PIN, as shown by reference numeral 30. A URL address for a secured site will be included in the message. The registrant must first answer several questions and enter a code in the message and the PIN will be revealed. If the registrant did not give an e-mail address, the same message will be mailed to the registrant and allow the registrant to obtain the information utilizing their computer. Alternatively, it might be possible to relay the PIN to the user without utilizing a computer.

The electronic signature card 32, as shown in FIG. 3, is an instrument that will simplify the use of one's electronic signature on any document, form or e-commerce credit transaction. The electronic signature card contains a smart chip with programming to decode stored electronic information and to generate a signal transmitted to one or more of the databases once a match is made between information contained on the card and information entered into the system by the individual. This information would be the PIN and/or the biometric information. It is contemplated that the electronic signature card would include an antenna used in conjunction with the smart chip to effectuate the purposes of the present invention. If this is the case, the electronic signature card would be inserted in a card reader associated with the registrant's computer. When the card is placed in the reader, a magnetic field will charge the computer chip on the electronic signature card. This charge is sufficient to activate the programming on the computer chip and processing will commence. The program will request that the user enter his personal identification number (PIN) and/or biometrics data. The program will compare the data entered against information stored in a scrambled format on the card. When the program is satisfied that the two pieces of data match, the program will generate an authorization key that is encrypted and transmitted to the web site that will issue the electronic signature and authentication number. However, it is contemplated that other means of relaying information from the electronic signature card to a computer could be utilized, such as employing a bar code reader, a magnetized reader, as well as other types of reading devices.

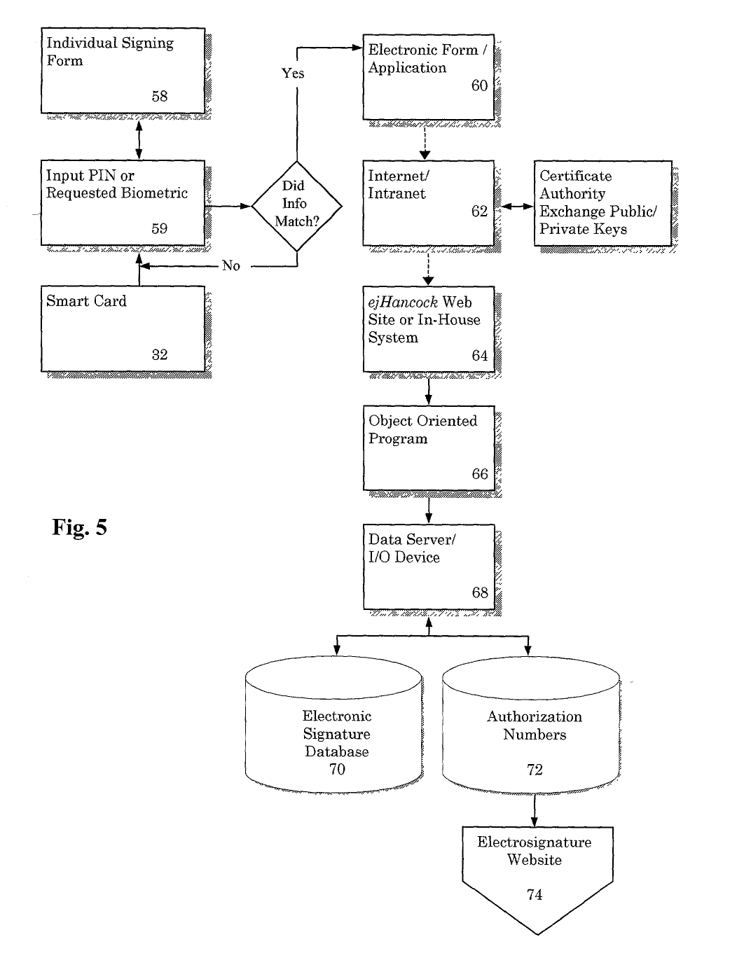

The biometric information referred to hereinabove could include fingerprints, voice recognition information, facial recognition information, retinal scans, body mass, body odor, hand geometry or any other physical information having the ability of identifying the individual. Depending on the security level assigned to a particular document, any or all of this biometric information will be stored on the electronic smart card. As will be described in more detail with respect to FIG. 5, the biometric information will be scanned into the system and will be compared to the information provided on the smart card. If a match is found, an encrypted communication will be sent to the web site of the present invention.

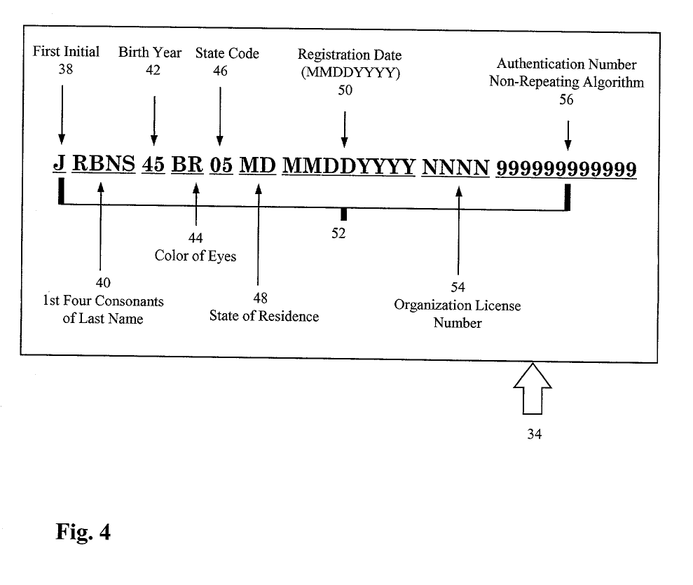

FIG. 4 details the electronic signature 34. This signature is not provided on the smart card 32, but is created by the system of the present invention to be affixed to the document. The electronic signature is denoted by reference numeral 52 and includes a multi-digit representation of information about the registrant. For example, the electronic signature could include the first initial 38 of the registrant, the first four consonants 40 of the last name of the registrant, the birth year of the registrant 42, the color of the registrant's eyes 44, as well as the state code 46 of the individual's residence along with the two letter postal abbreviation of the state of residence of the registrant 48. Additionally, the registration date in months, days and years, could also be provided as a portion of the electronic signature. It can be appreciated that the electronic signature need not include all of the above-described information, or can include additional information. In either case, a multi-digit digital signature would be produced. The electronic signature will be stored on a secured database only to be recalled and shared with vendors licensed to use the system. Associated with the electronic signature would be a vendor's license number 54 assigned to a particular vendor, as well as the authorization number 56 generated when the system verifies the identify of the individual. The entire number 52 constitutes the electronic signature do be affixed to the document.

The PIN database 24, as well as the registrant identification database 20 (as shown in FIG. 1) will be browsed only upon the satisfactory identification of an electronic signature utilizing the electronic signature card 32, as shown in FIG. 3, or by a positive hit created when the registrant inputs through a computer keyboard his full name, as well as a suffix supplied to him by the registration system.

Verification databases and the servers which process requests will be made secure and available only to government agencies, businesses and organization who have been licensed from the present system.

When the individual registrant registers to obtain the electronic signature card, that registrant would indicate the name of the vendor or vendors with which he will deal in future e-commerce transactions. Therefore, when the electronic signature is generated, it would include the vendor's license number 54 of that particular vendor.

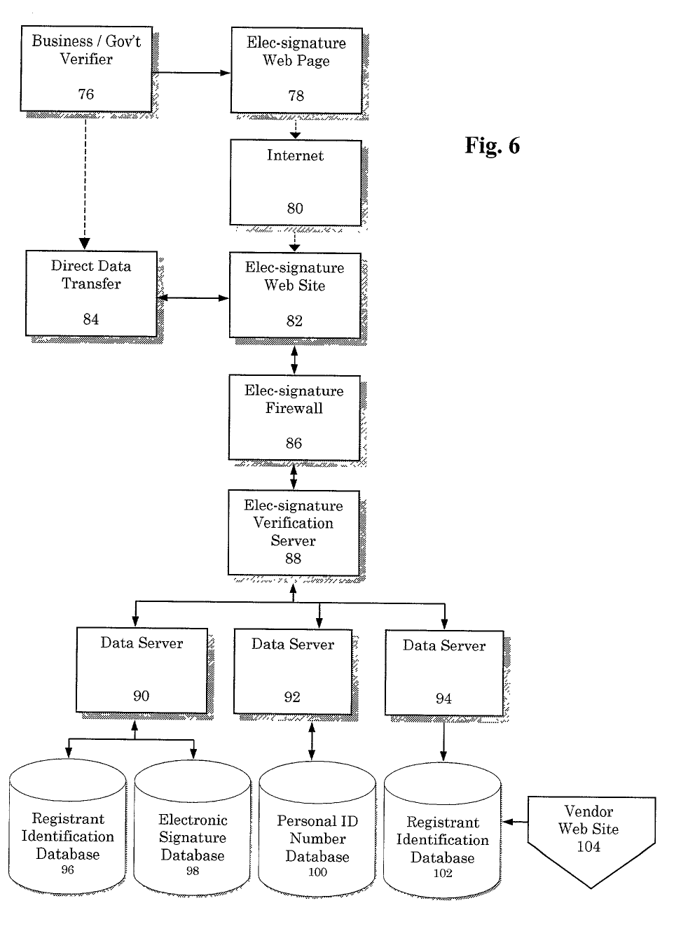

When the electronic signature card is generated, it would allow a comparison to be made to confirm the individual's identity and then produce an electronic signature including a one-time authentication number. The authentication number also includes a date/time stamp indicating when the document was executed, the number of key strokes entered by the individual signing the document, and a random prime number. The first 16 characters are stored and designated as the authentication code for this document. This would include the vendor's license number 54. A different authentication number will be generated with its next use. Therefore, when the registrant indicates the particular vendor or vendors with which the registrant wishes to conduct commercial transactions, the one-time authentication number for each transaction, will be generated and stored in the vendor's database. As shown in FIG. 5, when the registrant wishes to conduct a commercial transaction with a particular vendor, the electronic signature card, as shown in FIG. 3, will be inserted into a card reader and would remain there for the duration of the e-commerce transaction. Once the transaction is completed, the electronic signature card is retrieved by its owner. When the card is inserted and a particular form is provided on the registrant's screen as shown by reference numeral 58, the registrant would want his electronic signature to be affixed thereto. The form with the electronic signature 60 would then be transmitted over a particular wired or wireless Internet or Internet system 62 to either the in-house computer system of the vendor, or to the central electronic signature website 64. Communication between the individual and the central website would be accomplished through a public/private key infrastructure (PKI). Using this facility requires that a public key be exchanged through a certificate authority (CA). The CA will convert the public key to a private key and a digital certificate that will be used to trigger its processing activity resulting in the prediction of the one-time authentication number included in the electronic signature. An object oriented program 66 would then be used in conjunction with the electronic signature card to generate the one-time authentication number which would be sent to a data server or input/output device 68. This input/output device is associated with the central system which would include the electronic signature database 70, as well as the authentication numbers database 72. This information would also be transmitted back to the verification host site connecting box 74 with box 104 in FIG. 6.

A comparison is made by one of the authorized vendors, comparing the authentication number generated by the electronic signature card with the authentication number contained in its database. If a match results, the individual signing the form is verified. The electronic signature card can be subsequently used with either the same vendor or a different vendor. In either case, different authentication numbers would be generated than were generated during the first transaction. These numbers are compared to additional authentication numbers provided in the particular vendor's database. As previously indicated, the individual's signature can be verified without the use of the electronic signature card by the registrant correctly providing his or her full name and assigned suffix through a computer keyboard. The system would then request the registrant's PIN and transmit all of the data back to the electronic signature website which would then verify the registrant's name, suffix and PIN and the request would then be further processed.

Referring again to FIG. 5, a special reader 59 can be utilized with the present invention. This reader would include one or more scanning devices, allowing the individual to physically enter one or more of the biometric information initially provided by the individual and included in the smart card 32. This information, along with the PIN, would generate a signal from the smart card 32 transmitted to the central system enabling the electronic signature to be provided if a match is determined in the smart card and the authorization code generated in the main system's database is equal to the authorization code generated by the appropriate vendor's database.

FIG. 6 illustrates the manner in which a vendor or government user can gain access to the required information through the central website or by direct data transfer. Each particular vendor or government user would sign up with the present system and obtain a vendor number at reference numeral 76. These commercial users would gain access to the electronic signature page 78 through the Internet 80 or by a direct data access at reference numeral 84. In both instances, the commercial user must be required to pass through an electronic signature firewall 86. In the case of utilizing the Internet, the commercial user would also gain access to the electronic signature website 82. An electronic signature verification server 88 will be employed in conjunction with one or more data servers 90, 92 and 94. As shown in FIG. 6, data server 90 is used in conjunction with the registrant identification database 96, as well as the electronic signature database 98. The data server 92 is used with respect to the PIN database 100 and the data server 94 is used with respect to the authorization number database 102. Utilizing this configuration, on-line signatures can be reviewed via the Internet, or through a private Intranet. Licensed vendors can also batch series of requests for verification and transmit them to different collection sites that would be maintained by the system of the present invention. They will be collected and processed in a batch mode with a 24 hour turn-around. Results will be transmitted back to the collection site and placed in a mailbox for vendor pick-up.

The vendor or government database system shown in FIG. 6 is in communication with the main database through boxes 74 and 104. Therefore, when a document is approved by the individual and the authorization number created by the database shown in FIGS. 5 and 6 match, the electronic signature is sent to the individual's computer for affixation. At this point, the document, including the electronic signature, would be sent to, and be retained in, one or both of the main database and the vendor database.

Although the individual can alter the document prior to affixing the electronic signature thereto, the number of keystrokes used to change the document is sent to the various databases and is used to formulate the authentication number, along the entire length of the document. Therefore, if the individual or another person endeavors to change the document after it is electronically signed, a comparison can be made utilizing the number of keystrokes needed to generate the document. Consequently, if the vendor retrieves the document at a later time, the aforementioned comparison is made and a determination is also made regarding whether the document was altered subsequent to the electronic signature as applied to the document.

Although the present invention has been described in connection with the preferred form of practicing it, those of ordinary skill in the art will understand that many modifications can be made thereto within the scope of the claims that follow. For example, the number of digits included in the electronic signature can be altered based upon the types of information included therein. Accordingly, it is not intended that the scope of the invention in any way be limited by the above description, but instead, be determined entirely by reference to the claims that follow.

We claim:

1. A system for generating an electronic signature, comprising:
registration means allowing an individual to provide personal information to a central database;
said registration means allowing the individual to designate at least one vendor;
said central database producing an issued personal identification number (PIN) transmitted to the individual and stored in said central database;
electronic signature generation device provided at said central database for generating at least a partial electronic signature based upon said personal information, said partial electronic signature stored at said central database;
at least one vendor database including said PIN or said partial electronic signature for each individual registered with that vendor;
a first device for comparing said issued personal identification number with a personal identification number entered by the individual, said device generating a first authentication code transmitted to said at least one vendor database, if a successful match is produced; and
a second device provided at said at least one vendor database for generating a second authentication code, said second device provided with a means for generating an electronic signature including said second authentication code if said second authentication code matches said first authentication code.

2. The system in accordance with claim 1, further including a smart card issued to the individual, said smart card including said issued personal identification number.

3. The system in accordance with claim 2, wherein said smart card generates said first authentication code.

4. The system in accordance with claim 2, wherein said smart card includes biometric information of the individual.

5. The system in accordance with claim 4, further including a reader for reading said biometric information of the individual.

6. The system in accordance with claim 5, wherein said biometric information includes a retinal scan.

7. The system in accordance with claim 5, wherein said biometric information includes fingerprints.

8. The system in accordance with claim 1, wherein said electronic signature includes a specific number assigned to the vendor.

9. The system in accordance with claim 1, including means for allowing the individual to review a document produced by at least one vendor and returning said document for said electronic signature to be affixed thereto.

10. The system in accordance with claim 9, further including means for allowing the individual to alter the document produced by at least one vendor prior to said electronic signature to be affixed thereto.

11. The system in accordance with claim 10, wherein the number of keystrokes used to alter the document is sensed and transmitted and retained in said central database.

12. The system in accordance with claim 1, wherein said first and second authentication codes are generated only once.

13. The system in accordance with claim 1, wherein a credit risk is determined for the individual and is stored in said central database.

14. A method for producing an electronic signature to be affixed to a document communicated between a vendor and an individual over a communication system, comprising the steps of:
the individual providing personal information to a central database;
said central database producing a personal identification number (PIN), said personal identification number retained in said central database and transmitted to the individual;
allowing at least one vendor to establish a vendor database in communication with said central database and individual;
allowing the individual to register with at least one of said vendors;
generating at least a partial electronic signature based upon said personal information, said partial electronic signature and said PIN for each individual stored at said central database and an appropriate vendor database;
reviewing a document transmitted from one of the vendors to the individual;
the individual transmitting said PIN to said central database;
comparing said PIN transmitted to said central database to said PIN stored in said database;
generating a first authentication code transmitted to said vendor database if said previous comparing step is successful;
generating a second authorization code in said vendor database to be compared to said first authentication code;
producing an electronic signature including said second authentication code if said first and second authentication codes are identical; and
affixing said electronic signature to the document.

15. The method in accordance with claim 14, further including the step of issuing a smart card to the individual, said smart card including said PIN.

16. The method in accordance with claim 15, including the step of said smart card generating said first authentication code.

17. The method in accordance with claim 15, further including the step of including biometric information of the individual on said smart card.

18. The method in accordance with claim 17, further including the steps of providing a reader for said smart card and reading biometric information directly from the individual prior to generating said first authentication code.

19. The method in accordance with claim 14, further including the step of assigning a specific number to each of the vendors, said specific number included in said electronic signature.

20. The method in accordance with claim 14, further including the step of allowing the individual to alter the document prior to said electronic signature being affixed thereto.

21. The method in accordance with claim 20, further including the steps of recording the number of keystrokes used by the individual to alter the document and retaining said number of keystrokes in said central database.

22. The method in accordance with claim 14, further including the step of conducting a credit risk investigation for each individual.
